(19) United States
(12) Patent Application Publication
(10) Pub. No.: US 2025/0181081 A1
(43) Pub. Date: Jun. 5, 2025

(54) LOCALIZATION OF HORIZONTAL INFRASTRUCTURE USING POINT CLOUDS

(71) Applicant: Seegrid Corporation, Pittsburgh, PA (US)

(72) Inventors: Tom Panzarella, Haddonfield, NJ (US); Blane Rhoads, Pittsburgh, PA (US); John Spletzer, Nokomis, FL (US)

(21) Appl. No.: 18/842,229

(22) PCT Filed: Mar. 28, 2023
(86) PCT No.: PCT/US2023/016641

§ 371 Date: Aug. 28, 2024

Related U.S. Application Data
(60) Provisional application No. 63/324,193, filed on Mar. 28, 2022.

(51) Int. Cl. G05D 1/667; G05D 1/646; G05D 111/10

(52) U.S. Cl. CPC G05D 1/667; G05D 1/646; G05D 2111/17

(57) ABSTRACT

In accordance with one aspect of the inventive concepts, provided is a method and a system for horizontal infrastructure localization, comprising a robotic vehicle platform, such as an AMR, a mechanism for collecting sensor data, e.g., point cloud data, such as a LiDAR scanner or 3D camera, and a processor configured to process the sensor data to identify and determine a position and orientation of the horizontal infrastructure. The robotic vehicle processes the sensor data to identify a horizontal infrastructure, determine its pose, and then determine if an area of a horizontal surface of the horizontal infrastructure is clear for dropping a load, e.g., palletized load.

### CROSS REFERENCE TO RELATED APPLICATIONS

The present application claims priority to U.S. Provisional Appl. 63/324,193 filed Mar. 28, 2022, entitled LOCALIZATION OF HORIZONTAL INFRASTRUCTURE USING POINT CLOUDS, which is incorporated herein by reference in its entirety.

The present application may be related to U.S. Provisional Appl. 63/430, 184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement, U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; US Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. Provisional Appl. 63/346,483 filed on May 27, 2022, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to U.S. Provisional Appl. 63/324,182 filed on Mar. 28, 2022, entitled A Hybrid, Context-Aware Localization System For Ground Vehicles; U.S. Provisional Appl. 63/324,184 filed on Mar. 28, 2022, entitled Safety Field Switching Based On End Effector Conditions; U.S. Provisional Appl. 63/324,185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. Provisional Appl. 63/324,190 filed on Mar. 28, 2022, entitled Passively Actuated Sensor Deployment; U.S. Provisional Appl. 63/324,192 filed on Mar. 28, 2022, entitled Automated Identification Of Potential Obstructions In A Targeted Drop Zone; US Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. Patent Appl. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; US Design patent application 29/398,127, filed on July 26, 2011, U.S. Pat. No. D680,142, Issued on Apr. 16, 2013, entitled Multi-Camera Head; U.S. Design patent application Ser. No. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, U.S. Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, U.S. Publication Number 2022-0100195, published on Mar. 31, 2022, entitled Vehicle Object-Engagement Scanning System And Method; U.S. patent application Ser. No. 17/478,338, filed on Sep. 17, 2021, U.S. Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to the field of robotics vehicle, such as automated mobile robot (AMRs). In particular, the inventive concepts may be related to systems and methods in the field of detection and localization of horizontal infrastructure, which can be implemented by or in an AMR.

### BACKGROUND

A common drop location for forklift payloads in manufacturing and logistics facilities is horizontal infrastructure. This category includes lift tables, conveyors, pallet tops, tugger cart beds, industrial racks, and others. Horizontal infrastructure may vary widely in size and material, which can create challenges for its automated identification. In addition, the physical environment in which this infrastructure is typically located may be cluttered or not well-maintained.

It may be desirable for Autonomous Mobile Robots (AMRs) to use automated detection and localization to safely and accurately drop payloads onto horizontal infrastructure. However, automated detection and localization of the horizontal infrastructure can be challenging.

Existing approaches rely upon high-precision localization to drop the payload to the infrastructure location based on prior knowledge of the infrastructure's position and orientation in a common coordinate frame. As long as the AMR's pose estimate (position and orientation) from its localization system is highly accurate, and the infrastructure is static, this solution works. However, the AMR is effectively dropping the payload “blind.” As a result, it is not robust to errors in vehicle position/orientation when dropping the payload. For example, dropping a pallet onto a lift table when vehicle pose errors exceed the table's clearances can lead to a hanging pallet. The assumption that the drop location is static is also invalid for many types of horizontal infrastructures. For example, the location of the bed of an industrial cart can vary from run to run. In some cases, a lift table may have been rotated so that its orientation is also not as expected. The top of a pallet in a pallet stacking application may have dropped/settled from compression of the product on the pallet underneath. Highly accurate drops on horizontal infrastructures can, therefore, be difficult or impossible to reliably achieve.

### SUMMARY

In accordance with various aspects of the inventive concepts, provided is a robotic vehicle, comprising: a navigation system configured to autonomously navigate the vehicle to a location, a payload engagement apparatus configured to pick and/or drop a payload at the location; one or more sensors configured to collect three-dimensional (3D) sensor data of an infrastructure at the location; and at least one processor in communication with at least one storage device and configured to process the collected sensor data to perform an infrastructure localization analysis to determine if the infrastructure is a modeled infrastructure type and if so to determine if a horizontal surface of the infrastructure is obstruction free.

In various embodiments, the mobile robotics vehicle is an autonomous mobile robot forklift.

In various embodiments, the one or more sensors comprises at least one 3D sensor.

In various embodiments, the at least one 3D sensor comprises at least one 3D LiDAR scanner system.

In various embodiments, the at least one 3D sensor comprises at least one stereo camera and/or 3D camera.

In various embodiments, the one or more sensors includes one or more onboard vehicle sensors.

In various embodiments, the sensor data includes point cloud data.

In various embodiments, the at least one processor is further configured to determine features of the infrastructure and/or the horizontal surface from the sensor data and perform the infrastructure localization analysis based, at least in part, on the features of the infrastructure and/or the horizontal surface.

In various embodiments, the at least one processor is further configured to compare the features of the infrastructure and/or horizontal surface to features of the modeled infrastructure type to determine if the features of the infrastructure and/or horizontal surface indicate that the infrastructure at the location matches the modeled infrastructure type and if so the infrastructure is localized.

In various embodiments, the features of the modeled infrastructure type include dimensions of one or more edges of a modeled horizontal surface.

In various embodiments, the features of the modeled infrastructure type include dimensions of all edges of a modeled horizontal surface.

In various embodiments, the features of the modeled infrastructure type include dimensions of one or more edges of infrastructure surrounding and/or supporting the modeled horizontal surface.

In various embodiments, the at least one processor is further configured to localize the infrastructure based on one or more of the edges of the infrastructure matching one or more edges of the modeled infrastructure type.

In various embodiments, the features of the modeled infrastructure type include a height of a drop surface.

In various embodiments, the features of the modeled infrastructure type include an orientation of the drop surface.

In various embodiments, the features of the modeled infrastructure type include a surface density of the drop surface.

In various embodiments, the surface predefined as a number of points or a point density, wherein the point density is a number of points per square meter of surface.

In various embodiments, the at least one processor is further configured to localize the infrastructure based on one or more of the edges of the horizontal surface matching one or more edges of the modeled horizontal surface.

In various embodiments, the at least one processor is further configured to generate a volume of interest (VOI) that has the same or greater dimensions than the payload and to use the VOI to determine if the horizontal surface is obstruction free.

In various embodiments, the at least one processor is further configured to localize the infrastructure based on the height and orientation of the drop surface matching the modeled infrastructure type.

In various embodiments, the dimensions of the VOI are the same as the dimensions of the payload.

In various embodiments, if the infrastructure is localized, the processor is further configured to associate the VOI with the horizontal surface and process the sensor data to determine if an obstruction is indicated within the VOI.

In various embodiments, if an obstruction is not indicated within the VOI, the processor is further configured to generate a signal indicating that the horizontal infrastructure is obstruction free.

In various embodiments, if the horizontal infrastructure is obstruction free, the payload engagement apparatus is configured to process the signal to deliver the payload to the horizontal surface.

In various embodiments, if an obstruction is indicated within the VOI, the processor is further configured to generate a signal indicating that the horizontal infrastructure is not obstruction free.

In various embodiments, if the horizontal infrastructure is not obstruction free, the payload engagement apparatus is configured to process the signal to abort delivery of the payload to the horizontal surface.

In accordance with another aspect of the inventive concepts, provided is a method of horizontal infrastructure assessment, comprising: providing a robotic vehicle comprising a navigation system configured to autonomously navigate the vehicle to a location, a payload engagement apparatus configured to pick and/or drop a payload at the location, one or more sensors, and at least one processor in communication with at least one storage device; the one or more sensors collecting three-dimensional (3D) sensor data of an infrastructure at the location; and the at least one processor processing the collected sensor data to perform an infrastructure localization analysis to determine if the infrastructure is a modeled infrastructure type and if so to determine if a horizontal surface of the infrastructure is obstruction free.

In various embodiments, the mobile robotics vehicle is an autonomous mobile robot forklift.

In various embodiments, the one or more sensors comprises at least one 3D sensor.

In various embodiments, the at least one or more sensors comprises at least one 3D LiDAR scanner system.

In various embodiments, the at least one 3D sensor comprises at least one stereo camera and/or 3D camera.

In various embodiments, the one or more sensors includes one or more onboard vehicle sensors.

In various embodiments, the sensor data includes point cloud data.

In various embodiments, the method further comprises determining features of the infrastructure and/or the horizontal surface from the sensor data and performing the infrastructure localization analysis based, at least in part, on the features of the infrastructure and/or the horizontal surface.

In various embodiments, the method further comprises comparing the features of the infrastructure and/or horizontal surface to features of the modeled infrastructure type to determine if the features of the infrastructure and/or horizontal surface indicate that the infrastructure at the location matches the modeled infrastructure type and if so the infrastructure is localized.

In various embodiments, the features of the modeled infrastructure type include dimensions of one or more edges of a modeled horizontal surface.

In various embodiments, the features of the modeled infrastructure type include dimensions of all edges of a modeled horizontal surface.

In various embodiments, the features of the modeled infrastructure type include dimensions of one or more edges of infrastructure surrounding and/or supporting the modeled horizontal surface.

In various embodiments, the features of the modeled infrastructure type include a height of a drop surface.

In various embodiments, the features of the modeled infrastructure type include an orientation of the drop surface.

In various embodiments, the features of the modeled infrastructure type include a surface density of the drop surface.

In various embodiments, the surface predefined as a number of points or a point density, wherein the point density is a number of points per square meter of surface.

In various embodiments, the method further comprises localizing the infrastructure based on one or more of the edges of the infrastructure matching one or more edges of the modeled infrastructure type.

In various embodiments, the method further comprises localizing the infrastructure based on one or more of the edges of the horizontal surface matching one or more edges of the modeled horizontal surface.

In various embodiments, the method further comprises localizing the infrastructure based on the height and orientation of the drop surface matching the modeled infrastructure type.

In various embodiments, the method further comprises generating a volume of interest (VOI) that has the same or greater dimensions than the payload and using the VOI to determine if the horizontal surface is obstruction free.

In various embodiments, the dimensions of the VOI are the same as the dimensions of the payload.

In various embodiments, the method further comprises if the infrastructure is localized, associating the VOI with the horizontal surface and processing the sensor data to determine if an obstruction is indicated within the VOI.

In various embodiments, the method further comprises if an obstruction is not indicated within the VOI, generating a signal indicating that the horizontal infrastructure is obstruction free.

In various embodiments, the method further comprises if the horizontal infrastructure is obstruction free, the payload engagement apparatus processing the signal to deliver the payload to the horizontal surface.

In various embodiments, the method further comprises if an obstruction is indicated within the VOI, generating a signal indicating that the horizontal infrastructure is not obstruction free.

In various embodiments, the method further comprises if the horizontal infrastructure is not obstruction free, the payload engagement apparatus processing the signal to abort delivery of the payload to the horizontal surface.

### BRIEF DESCRIPTION OF THE DRAWINGS

Aspects of the present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concepts. In the drawings:

FIG. 1A provides a perspective view of a robotic vehicle 100, in accordance with aspects of inventive concepts.

FIG. 1B provides a side view of a robotic vehicle with its load engagement portion retracted, in accordance with aspects of inventive concepts.

FIG. 1C provides a side view of a robotic vehicle with its load engagement portion extended, in accordance with aspects of inventive concepts.

FIG. 2 is a block diagram of an embodiment of an AMR 100, in accordance with aspects of inventive concepts.

FIG. 3 is a side view of a robotic vehicle localizing a horizontal infrastructure, in accordance with aspects of inventive concepts.

FIG. 4 is a flow diagram of an example method of localizing a horizontal infrastructure, in accordance with aspects of inventive concepts.

FIG. 5A is a perspective view of an embodiment of a horizontal infrastructure comprising a horizontal surface with four edges, in accordance with aspects of inventive concepts.

FIG. 5B shows the results of localizing the horizontal infrastructure of FIG. 5A, in accordance with aspects of inventive concepts.

FIG. 5C is a perspective view of a pallet positioned on the horizontal surface of FIG. 5A, in accordance with aspects of inventive concepts.

FIG. 5D shows the results of localizing the pallet of FIG. 5C and the horizontal infrastructure of FIG. 5A, in accordance with aspects of inventive concepts.

FIG. 6A is a perspective view of a first AMR delivering a pallet with a payload to a horizontal infrastructure that is connected to a second AMR, in accordance with aspects of inventive concepts.

FIG. 6B shows the results of localizing the horizontal infrastructure of FIG. 6A, in accordance with aspects of inventive concepts.

FIG. 7A is a perspective view of an embodiment of a horizontal infrastructure comprising two horizontal surfaces with rollers, in accordance with aspects of the inventive concepts.

FIG. 7B is a perspective view of an AMR delivering a pallet to the horizontal infrastructure of FIG. 7A, in accordance with aspects of inventive concepts.

FIG. 8A is a perspective view of an embodiment of a horizontal infrastructure comprising two horizontal surfaces, in accordance with aspects of the inventive concepts.

FIG. 8B shows the results of localizing a first horizontal surface of the horizontal infrastructure shown in FIG. 8A, in accordance with aspects of inventive concepts.

FIG. 9A is a perspective view of a first AMR delivering a pallet with a payload to a horizontal infrastructure that is connected to a second AMR, in accordance with aspects of inventive concepts.

FIG. 9B shows the results of localizing the horizontal infrastructure of FIG. 9A, in accordance with aspects of inventive concepts.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concepts may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concepts, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In the context of the inventive concepts, and unless otherwise explicitly indicated, a “real-time” action is one that occurs while the AMR is in-service and performing normal operations. This is typically in immediate response to new sensor data or triggered by some other event. The output of an operation performed in real-time will take effect upon the system so as to minimize any latency.

Aspects of inventive concepts herein address the problem of automated detection and localization of horizontal infrastructure, such as a table, shelf, cart or cart bed, industrial rack, rack system, or conveyor belt and/or rollers, as examples. The inventive concepts are not, however, limited to any particular types of horizontal surface. A horizontal surface as used herein can be any horizontal surface that can support a payload to be picked and/or dropped, whether a solid surface, mesh, grid, or wire surface, or a plurality of supports, such as a plurality of beams, that collectively form or provide a horizontal structure and/or support for a payload to be picked and/or dropped. In various embodiments, this can be used by autonomous mobile robots (AMRs) to safely and accurately drop payloads onto infrastructure having a horizontal surface, referred to herein as a horizontal infrastructure. In various embodiments, an AMR can be configured with the necessary sensors, processors, memory, computer program code and other technologies necessary to perform automated detection and localization of the horizontal infrastructure.

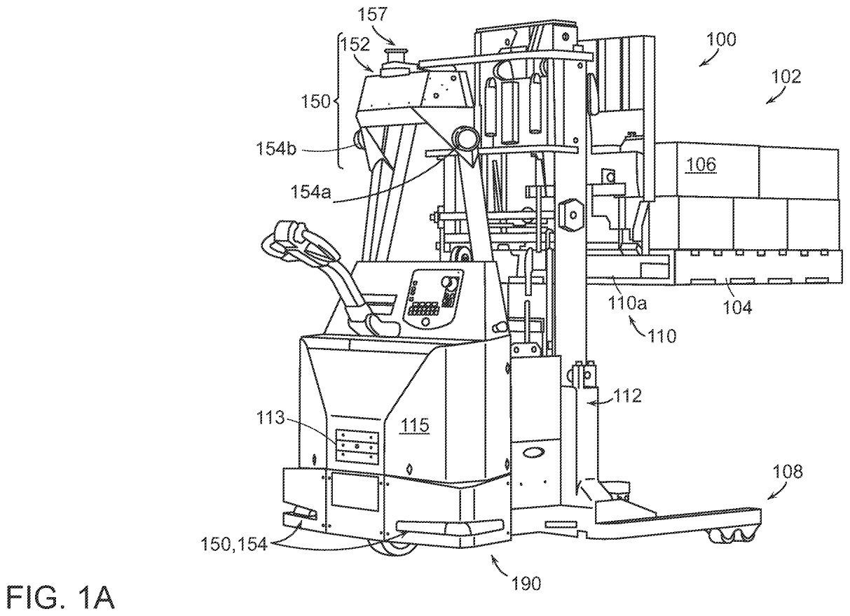

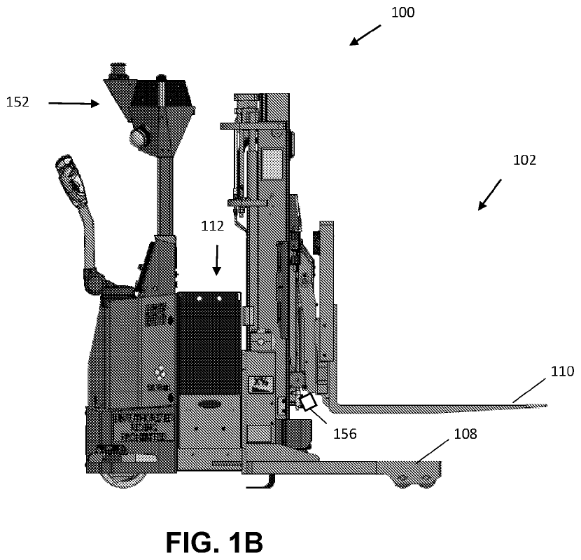

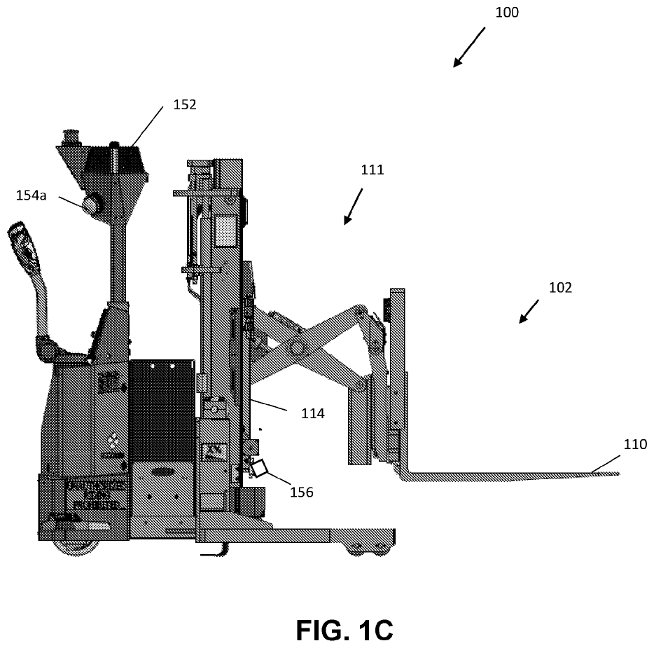

Referring to FIGS. 1A through 1C, collectively referred to as FIG. 1, shown is an example of a robotic vehicle 100 in the form of an AMR forklift 100 that can be configured with the sensing, processing, and memory devices and subsystems necessary and/or useful for performing methods of automated horizontal infrastructure localization, in accordance with aspects of the inventive concepts. In this embodiment, the robotic vehicle 100 takes the form of an AMR lift truck, but the inventive concepts could be embodied in any of a variety of other types of robotic vehicles and AMRs, including, but not limited to, pallet trucks, tuggers, and the like. In some embodiments, robotic vehicles described herein can employ Linux, Robot Operating System ROS2, and related libraries, which are commercially available and known in the art.

In this embodiment, the robotic vehicle 100 includes a payload area 102 configured to transport a pallet 104 loaded with goods, which collectively form a palletized payload 106. To engage and carry the pallet 104, the robotic vehicle may include a pair of forks 110, including first and second forks (or fork tines) 110a, b. Outriggers 108 extend from a chassis 190 of the robotic vehicle in the direction of the forks to stabilize the vehicle, particularly when carrying the palletized load. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a mast 114 that enable the robotic vehicle 100 to raise, lower, extend and retract the forks to pick up and drop off loads, e.g., palletized payloads 106. In various embodiments, the robotic vehicle may be configured to robotically control the yaw, pitch, and/or roll of the forks 110 to pick a palletized load in view of the pose of the payload and/or the horizontal surface that supports the payload.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system. In some embodiments, one or more of the sensors 150 can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, at least one sensor 150 is moving with a known velocity as part of the robotic vehicle 100.

In some embodiments, the sensors 150 can include one or more stereo cameras 152 and/or other volumetric sensors, sonar sensors, radars, and/or laser imaging, detection, and ranging (LiDAR) scanners or sensors 154, as examples. In the embodiment shown in FIG. 1, there are two LiDAR devices 154a, 154b positioned at the top left and right of the robotic vehicle 100. In the embodiment shown in FIG. 1, at least one of the LiDAR devices 154a,b can be a 2D or 3D LiDAR device. In alternative embodiments, a different number of 2D or 3D LiDAR devices can be positioned near the top of the robotic vehicle 100. Also, in this embodiment a LiDAR 157 is located at the top of the mast. Some embodiments LiDAR 157 is a 2D LiDAR used for localization.

The inventive concepts herein are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

In some embodiments, the sensors 150 can include sensors configured to detect objects in the payload area 102 and/or behind the forks 110a,b. The sensors 150 can be used in combination with others of the sensors, e.g., stereo camera head 152, LiDAR 157, and/or LiDAR sensors 154a,b. In some embodiments, the sensors 150 can include one or more payload area sensors 156 oriented to collect 2D and/or 3D sensor data of the payload area 102 and/or forks 110. The payload area sensors 156 can include a 3D camera and/or a 2D or 3D LiDAR scanner, as examples. In some embodiments, the payload area sensors 156 can be coupled to the robotic vehicle 100 so that they move in response to movement of the actuators 111 and/or fork 110. For example, in some embodiments, the payload area sensor 156 can be slidingly coupled to the mast 114 or carriage so that the payload area sensors 156 move in response to up and down, left or right, and/or extension and retraction movement of the forks 110. In some embodiments, the payload area sensors 156 collect 3D sensor data as they move with the forks 110.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

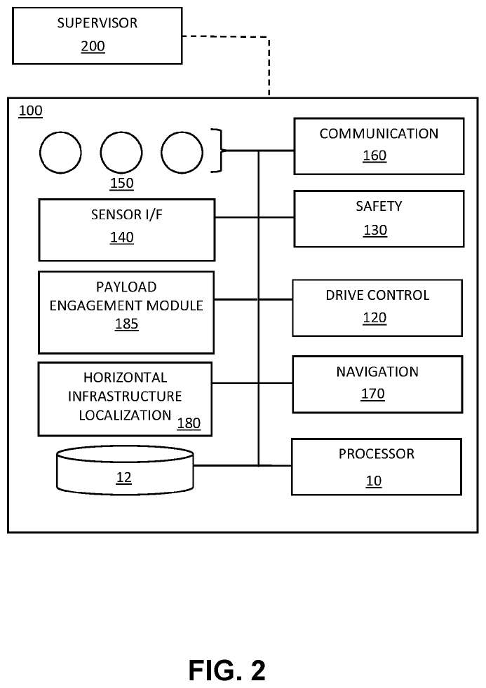

FIG. 2 is a block diagram of components of an embodiment of the robotic vehicle 100 of FIG. 1, incorporating technology for automated detection and localization of horizontal infrastructures, in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100 and/or to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other internal or external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or p reforms its tasks. The sensor data can include sensor data from one or more of the various sensors 150. As an example, in a warehouse setting the path could include one or more stops or locations along a route for the picking and/or the dropping of goods. The path can include a plurality of path segments. The navigation from one stop to another can comprise one or more path segments. The supervisor 200 can also monitor the robotic vehicle 100, such as to determine the robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle learns and stores the path for use in task performance and builds and/or updates an electronic map of the environment as it navigates. The path may be stored for future use and may be updated, for example, to include more, less, or different locations, or to otherwise revise the path and/or path segments, as examples. The path may include one or more pick and/or drop locations, and could include battery charging stops.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as an electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 170 configured to access environmental data, such as the electronic map, and path information stored in memory 12, as examples. The navigation module 170 can communicate instructions to a drive control subsystem 120 to cause the robotic vehicle 100 to navigate its path within the environment. During vehicle travel, the navigation module 170 may receive information from one or more sensors 150, via a sensor interface (I/F) 140, to control and adjust the navigation of the robotic vehicle. For example, the sensors 150 may provide 2D and/or 3D sensor data to the navigation module 170 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles. The robotic vehicle may also include a human user interface configured to receive human operator inputs, e.g., a pick or drop complete input at a stop on the path. Other human inputs could also be accommodated, such as inputting map, path, and/or configuration information.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors, e.g., sensors 154, detect objects in the path as a safety hazard, such sensor data can be used to cause the drive control subsystem 120 to stop the vehicle to avoid the hazard.

In various embodiments, the robotic vehicle 100 can include a payload engagement module 185. The payload engagement module 185 can process sensor data from one or more of the sensors 150, such as payload area sensors 156, and generate signals to control one or more actuators 111 that control the engagement portion of the robotic vehicle 100. For example, the payload engagement module 185 can be configured to robotically control the actuators 111 and mast 114 to pick and drop payloads. In some embodiments, the payload engagement module 185 can be configured to control and/or adjust the pitch, yaw, and roll of the load engagement portion of the robotic vehicle 100, e.g., forks 110.

The functional modules may also include a horizontal infrastructure localization module 180 configured to identify and localize a horizontal infrastructure, that is, estimate a position and orientation of a horizontal infrastructure using sensor data and feedback. The position and orientation of the horizontal infrastructure is referred to as a pose. The horizontal infrastructure could be a table, shelf, cart or cart bed, platform, conveyor, racking or racking system, or other horizontal surface configured to support a payload, such as a palletized load of goods.

In some embodiments, horizontal infrastructure localization module 180 is configured to process sensor data to generate a six-degree-of-freedom (x, y, z, roll, pitch, yaw) estimate of the infrastructure pose relative to the vehicle 100. In some embodiments, the six-degree-of-freedom (DOF) estimate is performed using continuous, discrete, and robust optimization techniques. In various embodiments, a properly equipped robotic vehicle 100 can use the robotic pose to provide feedback to its actuators 111 to accommodate for errors in vehicle pose and/or infrastructure pose to accurately and safely drop a payload 106 onto a horizontal surface of the infrastructure. The vehicle actuators 111 control the engagement portion, e.g., forks, of the robotic vehicle. In some embodiments, the horizontal infrastructure module 180 is configured to coordinate with one or more element of the robotic vehicle 100 to perform one or more of the methods described herein.

In accordance with one aspect of the inventive concepts, provided is a system for horizontal infrastructure localization, comprising: a robotic vehicle platform, such as an AMR 100; a mechanism for collecting sensor data 150, e.g., point cloud data, such as a LiDAR scanner 156 or 3D camera; and a local computer or processor 10 configured to process the sensor data to determine a position and/or orientation and/or shape of the horizontal infrastructure. The robotic vehicle 100 processes the sensor data to identify a horizontal infrastructure, and determine its pose, and then determine if an area of a horizontal surface of the horizontal infrastructure is clear for dropping a load, e.g., palletized load 106.

In accordance with another aspect of the inventive concepts, provided is a horizontal infrastructure localization method performed by a robotic vehicle 100, including processing the sensor data to identify a horizontal infrastructure, determine its pose (a position and orientation), and then determine if the horizontal surface indicated for receiving the payload 106 is unobstructed so that the payload can be safely dropped. This can be done, in some embodiments, by determining if a volume proximate and/or adjacent to, or superimposed on, the horizontal surface of the horizontal infrastructure is clear so that the payload 106 can be safely dropped on the horizontal surface.

In various embodiments, the method can comprise: detecting when the robotic vehicle 100 nears or is proximate to the horizontal infrastructure; distinguishing a drop surface (horizontal infrastructure) by recognizing a certain characteristic of the infrastructure, such as shape, dimensions, edges, height, curvature, color, and/or texture/spatial frequency of the infrastructure from sensor data; determining a location and orientation of the horizontal infrastructure relative to the robotic vehicle 100; and verifying that the surface is clear for dropping an item with no obstructions/obstacles present.

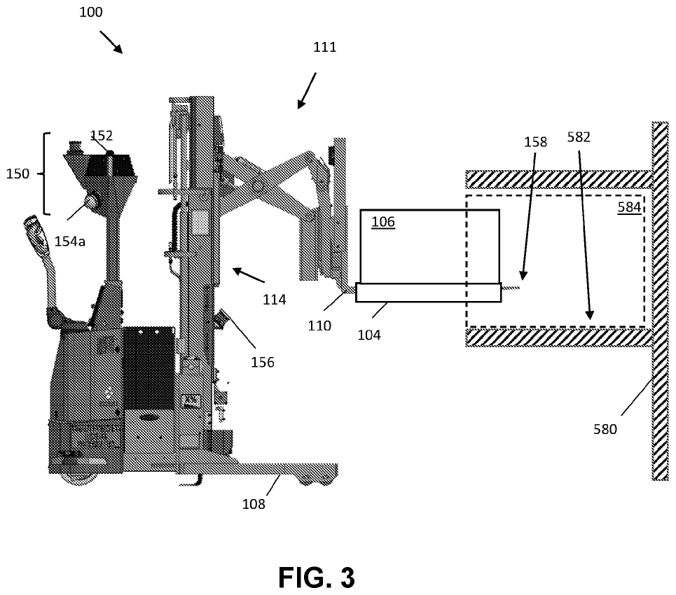

FIG. 3 shows a side view of the robotic vehicle 100 configured for horizontal infrastructure localization in accordance with aspects of the inventive concepts. In this embodiment, the robotic vehicle 100 includes a plurality of sensors 150, which can include 3D cameras, stereo cameras, e.g., stereo camera 152, LiDAR or other scanners 154, payload area sensors 156, and/or one or more fork tip scanners 158. The fork tip scanners 158, if included, can be 2D scanners and/or LiDAR scanners. As an example, in various embodiments, the fork tip scanners 158 can be as shown and described in US Patent Publication Number 2022-0100195, published on Mar. 31, 2022, which is incorporated herein by reference.

As shown in FIG. 3, in some embodiments, the robotic vehicle 100 uses the horizontal infrastructure localization module 180 to identify the horizontal structure at a designated drop location. In some embodiments, the robotic vehicle 100 has prior knowledge of the location and type of infrastructure at which a payload is to be dropped. The horizontal infrastructure localization module 180 uses sensor data to determine if: the drop surface is the correct shape/dimensions based upon any prior information; the drop surface is of suitable size for the payload being dropped; the AMR is able to drop to the surface based upon its relative position and orientation, and the motion limits of the actuators 111; and the infrastructure is free from obstructions.

Once the robotic vehicle navigates to the location, sensor data is used to locate the horizontal infrastructure 580 and/or the horizontal drop surface 582 at the location. In some embodiments, the robotic vehicle 100 uses the horizontal infrastructure localization module 180 to determine if the horizontal infrastructure 580 and/or the horizontal drop surface 582 is unobstructed so that the palletized load 106, on pallet 104, can be safely dropped on a horizontal drop surface 582. In some embodiments, e.g., prior to navigating to the location or thereafter, a volume of interest (VOI) 584 may be defined on, adjacent to, proximate to, superimposed on, and/or relative to the drop surface, wherein the VOI is greater than or equal to the volume of the payload 106 to be dropped. In some embodiments, the infrastructure is localized at the location by the horizontal infrastructure localization module 180 processing point cloud sensor data from one or more sensors, e.g., stereo camera 152, LiDARs 154, and/or payload area sensors 156. Once the horizontal infrastructure is localized, the point cloud data is processed to determine if there are any obstructions in the VOI to ensure that there is an unobstructed path for the robotic vehicle to deliver the payload to the identified horizontal surface 582. That is, if the point cloud data indicates that the VOI is unobstructed, then the horizontal surface is determined to be clear to receive the drop.

In various embodiments, therefore, the horizontal infrastructure localization module 180 can use one or more of the sensors 150 to acquire sensor data useful for determining if the horizontal surface 582 of the infrastructure 580 is free of obstacles as a precursor to determining whether a payload 106 (e.g., a pallet 104) can be dropped onto a horizontal drop surface 582. Robotic vehicles are one possible application of the horizontal infrastructure localization functionality, but the inventive concepts could also be employed with a manual forklift by an operator trying to drop a payload on an elevated horizontal surface where line-of-sight of the drop zone is not possible or difficult.

The functionality described herein could be integrated into any of a number of robotic vehicles 100, such as AMR lifts, pallet trucks, and tow tractors, to enable safe and effective interactions with horizontal infrastructures in the environment, such as a warehouse environment. This would be extremely valuable in hybrid facilities where both robotic vehicles and human-operated vehicles work in the same space, and where the robotic vehicle may not have complete knowledge of human operations. For example, a human operator may bring a tugger cart train for payload transfer, and the positioning of the cart can vary from run to run. With the inventive concepts described herein, in some embodiments, the robotic vehicle 100 will identify and localize the cart bed and use this feedback to accurately place its payload.

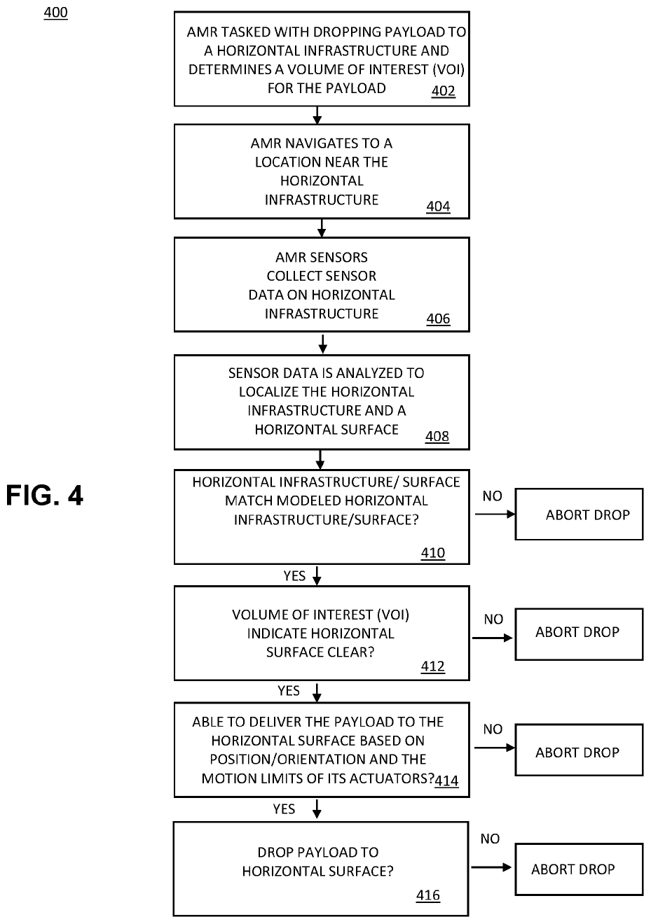

FIG. 4 is a flow diagram of an example embodiment of a method 400 of horizontal localization in accordance with aspects of the inventive concepts. According to an embodiment of the method, the robotic vehicle performs horizontal surface segmentation and then edge segmentation based on processing of the sensor data. The horizontal surface segmentation can include recognizing a horizontal surface and modeling the surface as a plane. The plane can be analyzed to determine its dimensions, height, and inclination, e.g., pitch and roll. It can also be analyzed to determine surface type, wherein a solid surface will be expected to have a greater point cloud density than a mesh wire surface. These parameters can be preloaded as part of the stored definition of the infrastructure type expected at a given location and the sensor data can be analyzed relative to the stored values. The surface segmentation can be accomplished in this manner.

These features as well as other features that are recognized by applying edge detection to the sensor data around the horizontal surface and defined plane can be used to validate the infrastructure by assessing whether the sensor data indicates the anticipated features of the expected infrastructure type. The validation is accomplished therefore by assessing a fit of the sensor data to the stored infrastructure features and parameters.

The VOI used for obstruction detection can be formed based on the height of the horizontal plane, wherein the plane can serve as a bottom boundary of the VOI. Edge detection can be used within the VOI to determine the presence of obstructions. Edges within the VOI, for example, can indicate an obstruction.

Referring to the example method 400 in FIG. 4, in step 402, a robotic vehicle 100, for example an AMR, is tasked with dropping its payload 106 to a horizontal infrastructure 580 at a drop location. In some embodiments, the robotic vehicle 100 and/or the horizontal infrastructure module 180 may be configured to define, store, and/or access information related to the expected pose of the horizontal infrastructure 580. In many instances, the expected pose information may be confirmed and/or improved by methods described herein.

In some embodiments, the robotic vehicle 100 and/or the horizontal infrastructure module 180 may be configured to define, store, and/or access a plurality of infrastructure types, each type being defined by a set of parameters. In some embodiments, the robotic vehicle can have access to a database or electronic library of parameterized horizontal infrastructures to be selectively associated with a pick or drop location. The parameters can define different features of the infrastructure types. As examples, infrastructure types can include different racks, rack shelves, carts, tables, pallets, beds, platforms, conveyor belts, rollers or any other type of infrastructure having or defining a support surface. The parameters can include dimensions, such as length, width, depth, and height of the horizontal surface intended for the drop. The robotic vehicle 100 will associate a horizontal infrastructure type and its horizontal surface features with a predetermined pick or drop location.

For example, in some embodiments, the horizontal infrastructure module 180 may be configured to define, store, and/or access a descriptor associated with a horizontal infrastructure 580. In some embodiments, the descriptor includes one or more concise parameterizations or models of the horizontal infrastructure 580. For example, if the horizontal infrastructure 580 was a static table in the environment, there may be just one model. However, if the horizontal infrastructure 580 is a cart and there are three types of carts in a facility, the descriptor could contain three models. In this event, the methods described herein would identify the correct cart model and localize the cart using it.

In some embodiments, a model is parametrized by a drop surface and one or more edges. In some embodiments, a model is parameterized by a drop surface and four edges (front, back, left, right). In some embodiments, drop surface of the model includes the expected dimensions of the horizontal infrastructure 580 (width, depth, height). In some embodiments, the drop surface dimension information of the model includes ranges. If the ranges are relatively broad, this is indicated by “overrides” in the descriptor that increase feature segmentation tolerances.

In some embodiments, the edge set in the model contains between one and four edges. In some embodiments, each edge has a type and an offset. The type provides at least one cue to the horizontal infrastructure module 180 regarding on how to segment the edge. In some embodiments, there are four edge types: planar, boundary, obstruction and virtual (see more details in connection with step 408. If the model has less than four edges, it is implied that the missing edges are virtual edges. Virtual edges cannot be segmented directly, and are instead inferred through a combination of the other edges and the drop surface dimensions.

The offset represents the translation between the physical edge being segmented and the edge of the drop surface. They are often the same, but do not have to be. A non-zero offset allows a different edge of the horizontal infrastructure 580 to be used as a feature for localization when appropriate, for example if the drop surface was inset into the horizontal infrastructure 580. An example of such a situation would apply when localizing and imaging the rollertop cart where the drop surface (rollers) is within the cart's physical left/right edges.

With prior knowledge of the payload and the type and parameters of the horizontal infrastructure 580 and/or horizontal surface 582, the horizontal infrastructure localization module 180 will define a volume of interest (VOI) 584 for the payload 106. In various embodiments, the VOI is generated based on the dimensions of the payload 106, e.g., so that the payload fits within the dimensions of the VOI. In various embodiments, the VOI 584 comprises dimensions that are greater than or equal to the dimensions of the payload 106. In some embodiments, the VOI is defined by onboard functionality of the robotic vehicle 100. In some embodiments, the VOI is communicated to the robotic vehicle 100 from an external source.

In step 404, the AMR 100 auto navigates to the horizontal infrastructure location to drop off its payload 106. In step 406, one or more of the AMR sensors 150, such as sensors 152, 154, and/or 156, scans the region at the drop location where the infrastructure 580 is located to collect sensor data. The sensors can be exteroceptive sensors (e.g., a 3D/2D LiDAR, stereo cameras, 3D cameras etc.), that collect 2D and/or 3D point cloud data. The sensors can scan the horizontal infrastructure 580 from a single scan or multiple scans taken from at least one precessing or actuated sensor to provide better coverage and/or denser point clouds of the horizontal infrastructure 580.

In step 408, the horizontal infrastructure localization module 180 analyzes the sensor data to attempt to identify and localize the horizontal infrastructure 580. In some embodiments, the horizontal infrastructure localization module 180 applies infrastructure identification and localization algorithms to the sensor data to determine if the expected horizontal infrastructure can be identified based on features extracted from the sensor data. The horizontal infrastructure localization module 180 may extract different features from the sensor data. The features that are relevant for characterizing a specific horizontal infrastructure 580 and/or horizontal drop surface 582 may vary for different types of horizontal infrastructure 580 and horizontal drop surfaces 582.

For example, in some embodiments, the horizontal infrastructure localization module 180 may extract information indicating that the infrastructure is horizontal or substantially horizontal, e.g., ±3 degrees from horizontal. Note that in some instances some infrastructures (e.g., gravity roller conveyors) can be deliberately sloped. For the purposes of the inventive concepts, such sloped surfaces may be considered horizontal surfaces.

In some embodiments, the infrastructure identification and localization algorithms can include the horizontal infrastructure localization module 180 processing the sensor data to extract one or more edges of its horizontal surface and then attempt to identify and localize the horizontal infrastructure and/or its horizontal surface based on at least one of the edges. The processing of the edges can include attempting to fit one or more of the edges to the stored and expected infrastructure type and its horizontal surface. In some embodiments, these edges can also be leveraged to provide estimates of x-y position, as well as the yaw of infrastructure.

In various embodiments, a taxonomy of edges can be defined to characterize physical infrastructure. These edges can include boundary, obstruction, planar, and virtual edges, as examples. This taxonomy allows the approach to be applied to a wide range of horizontal infrastructure—conveyors, carts, racks, and many others. Boundary edges can be used to delineate the outside extent of the infrastructure, which may extend beyond the drop surface. Obstruction edges are hard boundaries that limit the placement of the payload on the drop surface. Containment fixtures, such as nests or corner guards, provide a vertical delineation of the infrastructure boundaries and are instances of obstruction edges. Planar edges are those obtained from the segmented drop surface when modeled as a plane. The sides of a traditional table would be examples of planar edges. Virtual edges can be used when there is no such physical edge in the real world. They cannot be detected from sensor measurements, but they may be inferred from other detected edges and the dimensions of the drop surface. An example of virtual edges would be when dropping a payload onto the side of a long conveyor where the left and/or right boundary has no physical demarcation.

By decomposing the drop surface into its edge set, the dimensions, x-y position and yaw of infrastructure can be estimated. Note the edge set for a single drop surface could contain multiple edge types.

In some embodiments, the horizontal infrastructure localization module 180 may extract different types of edges from the sensor data. In some embodiments, the horizontal infrastructure localization module 180 may extract boundary edges that delineate the outside extent of the horizontal infrastructure, which may extend beyond the horizontal drop surface. In some embodiments, the horizontal infrastructure localization module 180 may extract planar edges, which are those obtained from segmenting the horizontal drop surface, which can be modeled as a plane. The sides of a traditional table would be examples of planar edges. In some embodiments, the horizontal infrastructure localization module 180 may interpret virtual edges from the sensor data. Virtual edges are edges that cannot be detected with confidence from sensor measurements, but they may be inferred from other detected edges and the dimensions of the expected horizontal infrastructure and/or drop surface 582. An example of a virtual edge would be a back edge of a table that is not clearly detected as an edge in view of the orientation of the sensors relative to the back edge of the table.

In some situations, the parameters of the stored infrastructure type may include edge information that defines one or more edges of the drop surface and their respective dimensions. Each edge could be uniquely defined as one of the defined parameters.

In some embodiments, the horizontal infrastructure localization module 180 may extract obstruction edges, which are hard boundaries that limit the placement of the payload 106 on the drop surface 582. Examples of obstruction edges could be containment fixtures such as nests or corner guards that provide a vertical delineation of the infrastructure boundaries. Other examples of obstruction edges include, but are not limited to, one or more adjacent walls, rack uprights, and/or one or more vertical posts that are adjacent to the drop surface 582.

In some embodiments, the horizontal infrastructure localization module 180 may extract features with texture/spatial frequency, such as conveyor rollers or wheels. For example, roller spacing allows the rollers to be discriminated from the conveyor's frame so that the roller boundaries can be established.

In some embodiments, the horizontal infrastructure localization module 180 may extract visual features. For example, color/reflectivity of conveyor roller can vary dramatically from the conveyor frame. This difference can be used to identify the drop surface 582.

In some embodiments, the horizontal infrastructure localization module 180 may use the approaches described in connection with characterizing the horizontal infrastructure 580 and/or drop surface 582 to detect and/or identify obstructions on or near the horizontal infrastructure 580 and/or drop surface 582.

In step 410, the horizontal infrastructure localization module 180 compares characteristics of sensor data of the horizontal infrastructure 580 and/or drop surface 582 (from step 408) to information that has been previously provided to the horizontal infrastructure localization module 180 about the expected or modeled horizontal infrastructure and/or modeled drop surface 582. If the information from the measurements and analysis substantially matches the provided information, the method 400 continues then the horizontal infrastructure is localized. In some embodiments, if the horizontal infrastructure and/or drop surface cannot be localized, the drop is aborted safely.

In some embodiments, the horizontal infrastructure localization module 180 compares the measured shape of the horizontal infrastructure 580 and/or drop surface 582 to a previously provided shape. In some embodiments, the horizontal infrastructure localization module 180 compares the measured dimensions of the horizontal infrastructure 580 and/or drop surface 582 to previously provided dimensions. In some embodiments, the horizontal infrastructure localization module 180 compares the measured pose of the horizontal infrastructure 580 and/or drop surface 582 to a previous provided and expected pose associated with the stored type of infrastructure for the pick/drop location.

In some embodiments, the horizontal infrastructure localization module 180 is configured to compare edge information extracted from the sensor data to the edge information from the stored horizontal infrastructure type. In some embodiments, the horizontal infrastructure localization module 180 may validate the horizontal infrastructure if one or more of the extracted edges is determined to be a fit with a corresponding edge of the stored horizontal infrastructure type. A fit can be determined if an edge is in an expected location and/or orientation and has about the expected dimension and/or length, e.g., ±5%. In some embodiments, the horizontal infrastructure localization module 180 may validate the horizontal infrastructure if a plurality of the extracted edges is determined to be a fit with a corresponding plurality of edges of the stored horizontal infrastructure type. In various embodiments, at least one of the plurality of edges can be a virtual edge.

In step 412, the horizontal infrastructure localization module 180 will analyze the sensor data to determine if the localized horizontal drop surface 582 and the necessary VOI proximate the surface are free from obstructions, i.e., are unobstructed. In some embodiments, the horizontal infrastructure localization module 180 will determine from the sensor data if there is any occupancy and/or any edges within the VOI 584 that are not part of the horizontal infrastructure to make a determination of whether the payload 106 can be safely placed onto the localized horizontal drop surface. If the VOI is not clear of obstructions, i.e., free from unexpected edges and/or occupancy in view of the stored and expected horizontal infrastructure, the drop can be aborted for safety reasons.

In step 414, the robotic vehicle 100, e.g., using the horizontal infrastructure localization module 180, will determine if the robotic vehicle 100 is able to safely deliver the payload 106 to the drop surface 582 based on the position/orientation of the robotic vehicle, or the pose of the robotic vehicle, relative to the horizontal infrastructure 580 and/or drop surface 582 and the motion limits of its actuators 111. If, in step 414, the robotic vehicle, e.g., using the horizontal infrastructure localization module 180, determines that the drop cannot be safely made, the robotic vehicle 100 will either adjust its pose relative to the drop surface 582 until a safe drop determination can be made and/or abort the drop for safety reasons.

If the drop has not been aborted in one of steps 410, 412, or 414, the method will proceed to step 416 where the robotic vehicle 100 makes the drop. Once in place for the drop, localization feedback can also be used as inputs to one or more actuators to adjust side shift, pantograph extension, and/or carriage height to ensure a safe drop by the forks 110 is obtained.

In some embodiments, the steps of the method 400 described herein are performed as they were presented. In alternative embodiments, the steps of the method 400 can be performed in a different order and/or the steps or portions thereof could be omitted or combined in different ways.

In some embodiments, the horizontal infrastructure and/or drop surface described herein are solid surfaces. In some embodiments, the horizontal infrastructure and/or drop surface described herein are surfaces that comprise mesh and/or one or more gaps, e.g., between rollers there typically exist small gaps.

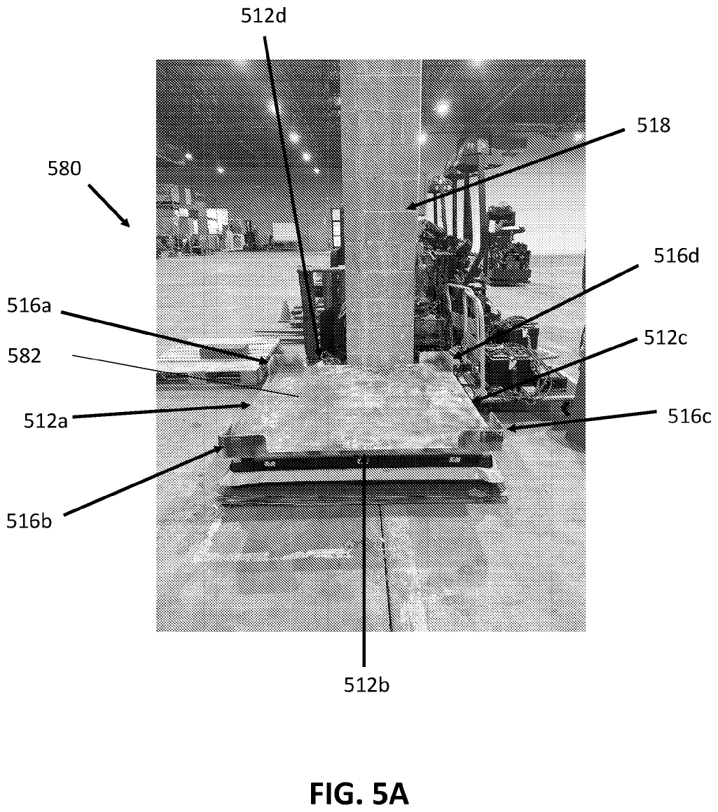

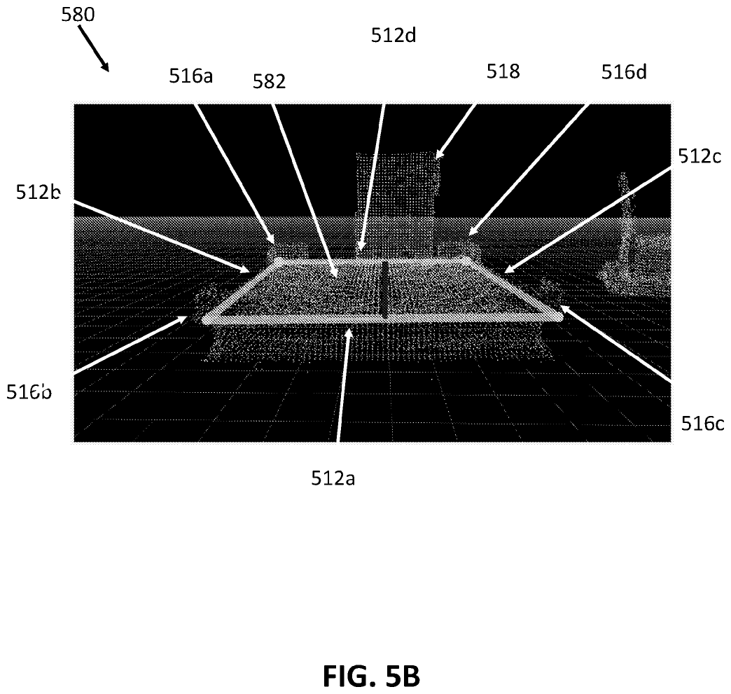

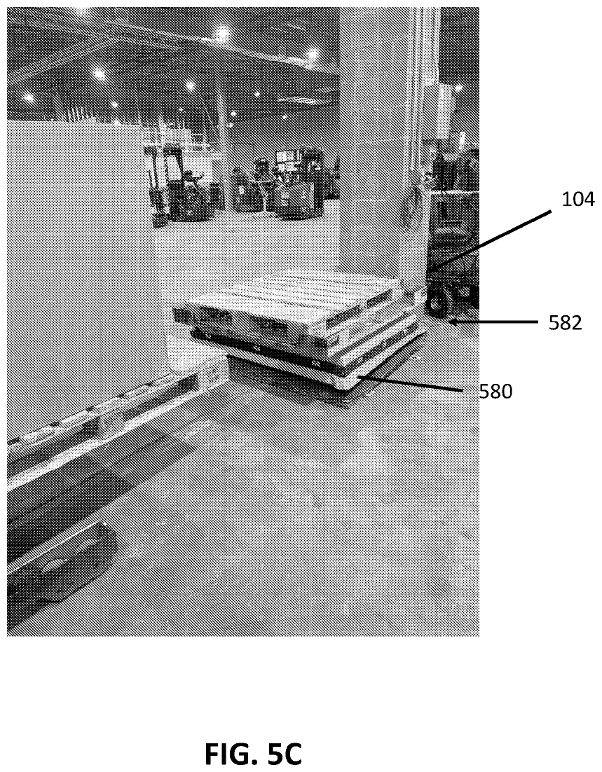

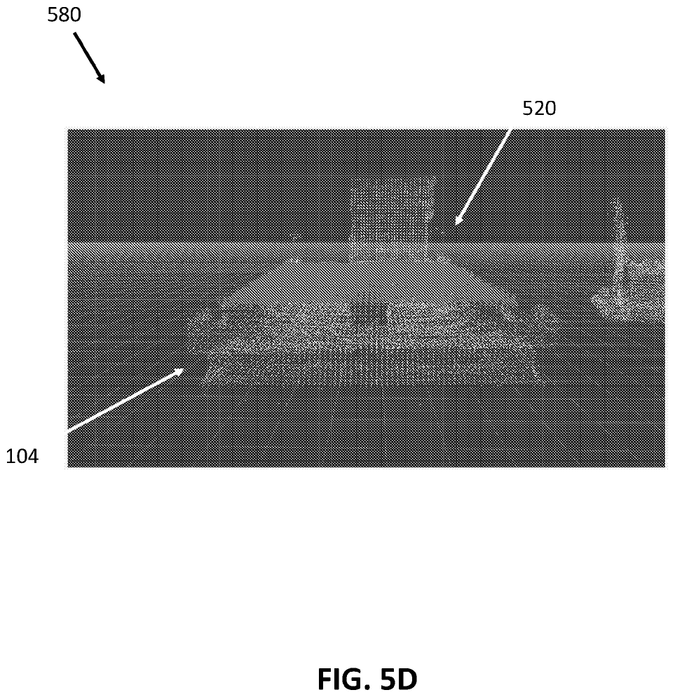

FIG. 5A is a perspective view of an embodiment of a horizontal infrastructure 580 comprising a horizontal drop surface 582 with four edges 512a-512d, in accordance with aspects of inventive concepts. In this example, the horizontal infrastructure shown in FIG. 5A also comprises four corner guards 516a-516d. The drop surface 582 is the located between the corner guards. In other instances, a horizontal infrastructure 580 may comprise a different number of corner guards or no corner guards. In the view shown in FIG. 5A, a column 518 is located behind the horizontal infrastructure 580.

FIG. 5B shows the results of processing sensor data to localize the horizontal infrastructure 580 of FIG. 5A, in accordance with aspects of inventive concepts. The results show the four edges 512a-512d of the horizontal infrastructure 580 extracted from the sensor data. The edges are examples of planar edges. Edge 512a is a front edge, edge 512b is a left edge, edge 512c is a right edge; and edge 512d is a rear or back edge. The four corner guards 516a-516d and the column 518 behind the horizontal infrastructure 580 are identifiable from the image.

FIG. 5C is a perspective view of a pallet 104 positioned on the horizontal surface 582 of infrastructure 580 of FIG. 5A, in accordance with aspects of inventive concepts.

FIG. 5D shows the results of processing the sensor data to localize the pallet 104 of FIG. 5C and the horizontal infrastructure of FIG. 5A, in accordance with aspects of inventive concepts. The results show the pallet 104 on the horizontal drop surface 582, as in FIG. 5C. The results also show a plane 520, which indicates an obstruction on the horizontal surface 582, i.e., the surface is not clear for receiving another item.

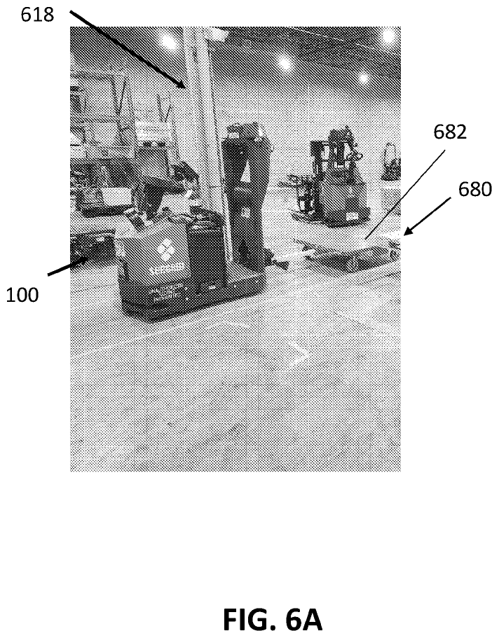

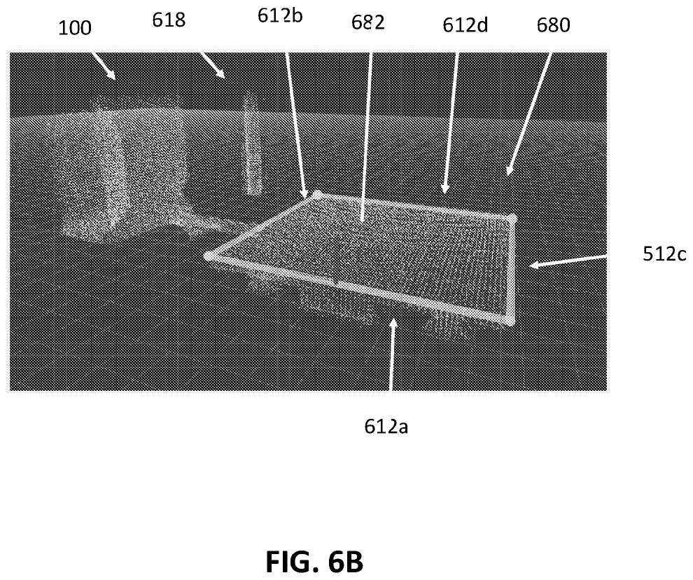

FIG. 6A is a perspective view of an AMR 100 pulling a cart 680 as a different type of horizontal infrastructure 680, in accordance with aspects of inventive concepts. In this embodiment, the AMR 100 is a tugger, rather than a fork truck. The cart 680 has a horizontal surface 682 for carrying loads, such as pallets. A column 618 is also nearby.

FIG. 6B shows the results of localizing the horizontal infrastructure 680 of FIG. 6A, in accordance with aspects of inventive concepts. The results show the four edges 612a-612d of the top surface of the cart 680 extracted from the sensor data. These edges can be used to identify the cart 680 and can also serve as boundaries of its horizontal surface 682. The nearby column 618 is also visible in the image.

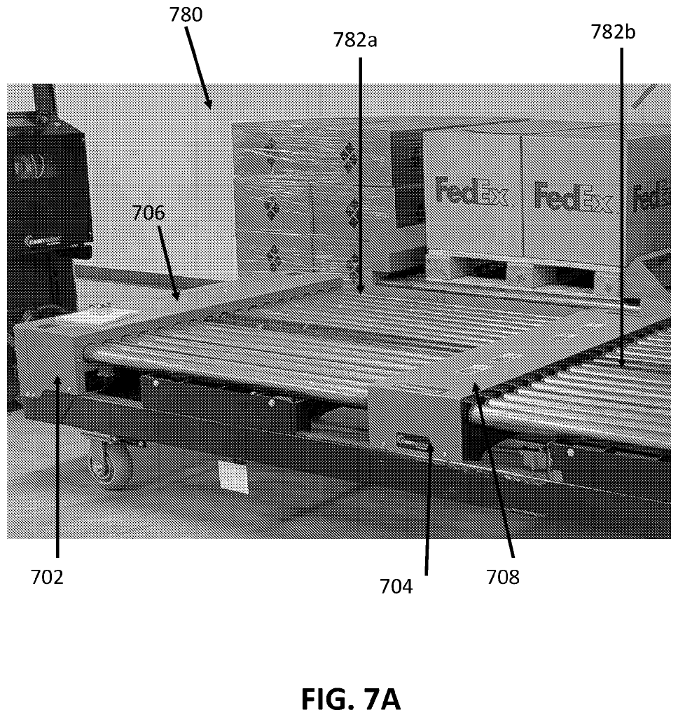

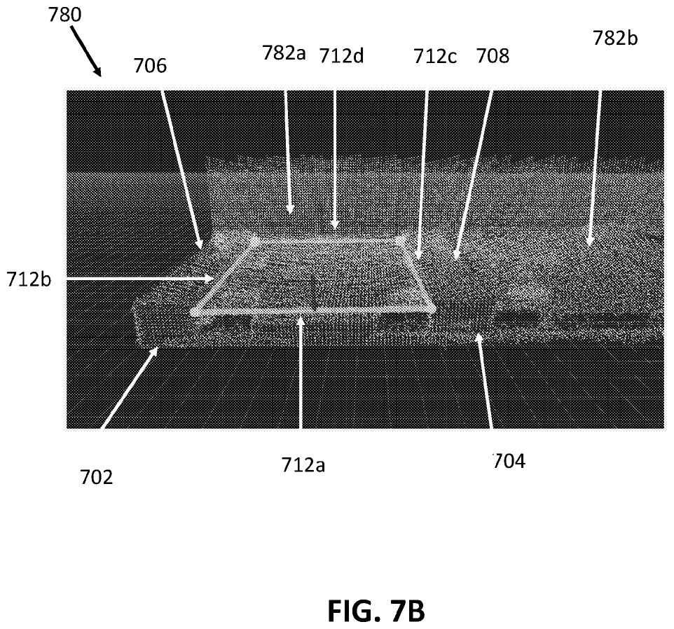

FIG. 7A is a perspective view of an embodiment of a horizontal infrastructure 780 comprising two horizontal surfaces 782s, 782b with rollers, in accordance with aspects of the inventive concepts. In FIG. 7A, the horizontal infrastructure 780 also comprises a first frame element having a first face 702 and a first top surface 706 and a second frame element having a second face 704 and a second top surface 708. The horizontal drop surface 782a lies between the first and second frame elements. For this horizontal infrastructure 780 the edges of the two horizontal surfaces 782a, 782b are offset vertically from, i.e., lower than, the top surfaces 706, 708 of the horizontal infrastructure 780.

FIG. 7B shows the results of localizing the horizontal infrastructure 780 of FIG. 7A, in accordance with aspects of inventive concepts. The results show the four edges 712a-712d representing the horizontal drop surface 782a of the horizontal infrastructure 780, which were extracted from the sensor data. In this example, the left edge of horizontal surface is offset from the left of the infrastructure. This is an example of a boundary edge with an offset. The image also shows a sensor data of the first face 702 and of the second face 704 of the first and second frames.

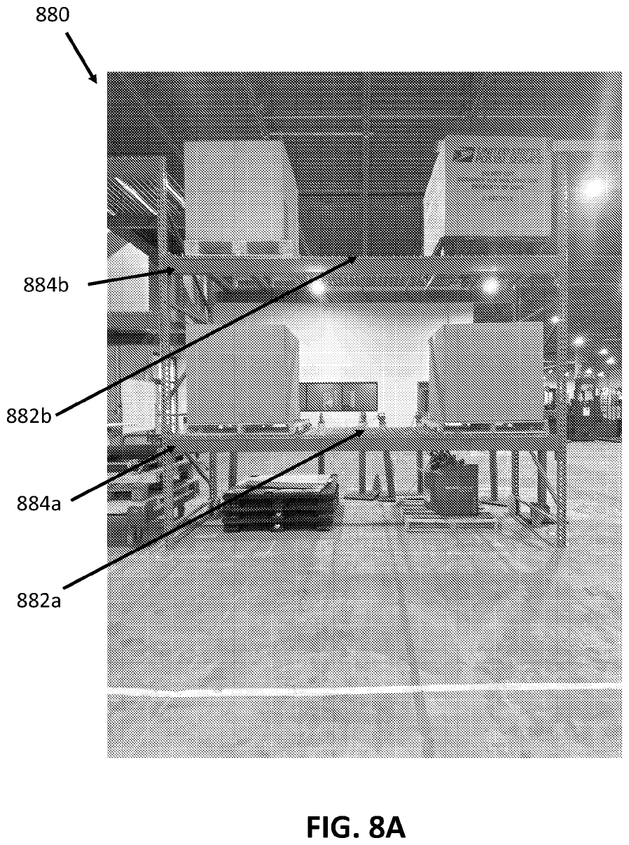

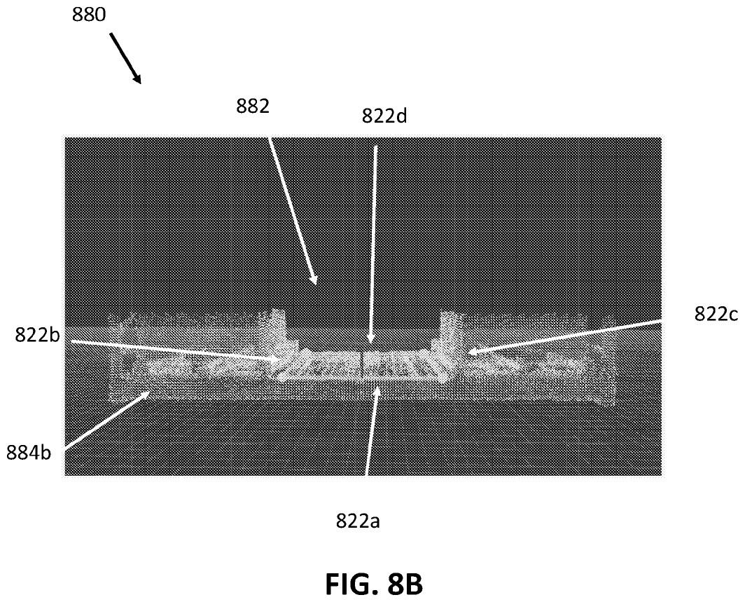

FIG. 8A is a perspective view of an embodiment of another horizontal infrastructure 880 in the form of a rack system comprising two horizontal shelves 884a, 884b above ground level, in accordance with aspects of the inventive concepts. In this embodiment, each shelf can include one or more horizontal drop surfaces. In this embodiment, each shelve includes three drop surfaces, right, left and center. In FIG. 8A, the left and right drop surfaces are occupied by palleted goods, leaving the center drop surfaces 882a, 882b open and available.

FIG. 8B shows the results of localizing the first horizontal drop surface 882 of the lower shelf 884a of the horizontal infrastructure 880 shown in FIG. 8A, in accordance with aspects of inventive concepts. The results show the four edges 812a-812d of the horizontal infrastructure 880 extracted from the sensor data, which define the horizontal drop surface 882a and show faces and edges of the shelf 884a. In this example, the left and right edges are examples of obstruction edges, and are defined by the neighboring loads.

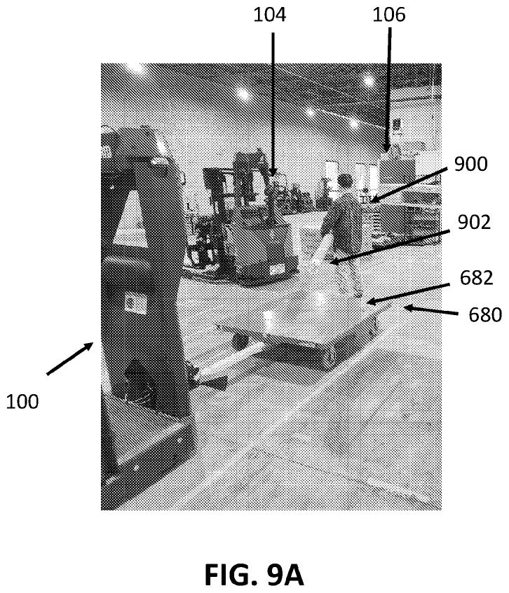

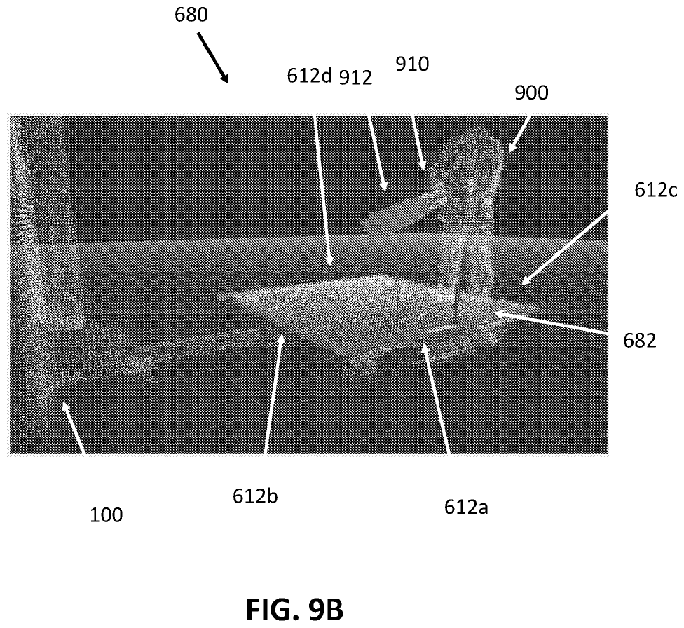

FIG. 9A is a perspective view of the AMR 100 pulling the cart 680 of FIG. 6A. The cart 680 includes horizontal surface 682, in accordance with aspects of inventive concepts. Near the cart 680 is a human 900 carrying a long object 910.

FIG. 9B shows the results of localizing the horizontal infrastructure (cart) 680 of FIG. 9A, in accordance with aspects of inventive concepts. The results show the four edges 612a-612d of the horizontal surface 682 of the horizontal infrastructure 680 extracted from the sensor data. The results also show the human 900 and the long object 910 being carried by the human. A portion of the long object 910 being carried that extends over the horizontal drop surface 682 is highlighted 912 as an obstruction that prevents dropping a load on the cart 680.

The sensor data shown and described in this application may be acquired by one or more sensors (e.g. 3D camera, stereo camera, 2D and/or 3D LiDAR) on an AMR 100. The sensor data can be represented as point cloud data or may be represented differently.

Aspects of the inventive concepts described herein would have general utility in the fields of robotics and automation, and material handling.

The systems and/or methods described herein have advantages and novelty over prior approaches. An advantage associated with systems and methods described herein is that the robotic vehicle 100 implementing the inventive concepts will avoid dropping a payload blindly onto a horizontal infrastructure based solely on a predetermined location of the horizontal infrastructure, which can be a trained location in a path of the vehicle. The robotic vehicle 100 uses the sensors 150 to collect sensor data of the infrastructure, and can use this sensor data to adjust its approach to the infrastructure as well as to actuate manipulators of the robotic vehicle 100 engagement portions, e.g., forks 110, to adjust the pose of the vehicle to ensure that the payload is dropped accurately and safely relative to the horizontal infrastructure. In the case that a safe drop is not possible due to mispositioning errors, this can be detected as well. The net result will be that the robotic vehicles will be able to operate in a wider range of facilities, and their behaviors will be safer. Damage to robotic vehicles 100, AMR payloads 106, and infrastructure will be reduced, and potential hazards to human operators working in proximity will also be mitigated.

Another advantage of the inventive concepts is the ability to generate a library of parameterized infrastructure types, each type defining characteristics and/or edge dimensions of the infrastructure type. The dimensions can include length, width, depth, and height of the infrastructure. Associating a type from the library with a drop or pick location is an efficient and reliable approach to performing localization of the infrastructure at the drop or pick location. A taxonomy, as described above, can be defined that provides a template for generating a file for each infrastructure type, making it relatively easy for a user to define new infrastructure types and add them to the library.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provide in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combined in any given way.

1. A robotic vehicle, comprising:
a navigation system configured to autonomously navigate the vehicle to a location, a payload engagement apparatus configured to pick and/or drop a payload at the location;
one or more sensors configured to collect three-dimensional (3D) sensor data of an infrastructure at the location; and
at least one processor in communication with at least one storage device and configured to process the collected sensor data to perform an infrastructure localization analysis to determine if the infrastructure is a modeled infrastructure type and if so to determine if a horizontal surface of the infrastructure is obstruction free.

2. The vehicle of claim 1, wherein the mobile robotics vehicle is an autonomous mobile robot forklift.

3. The vehicle of claim 1, wherein the one or more sensors comprises at least one 3D sensor.

4. The vehicle of claim 3, wherein the at least one 3D sensor comprises at least one 3D LiDAR scanner system.

5. The vehicle of claim 3, wherein the at least one 3D sensor comprises at least one stereo camera and/or 3D camera.

6. The vehicle of claim 1, wherein the one or more sensors includes one or more onboard vehicle sensors.

7. The vehicle of claim 1, wherein the sensor data includes point cloud data.

8. The vehicle of claim 1, wherein the at least one processor is further configured to determine features of the infrastructure and/or the horizontal surface from the sensor data and perform the infrastructure localization analysis based, at least in part, on the features of the infrastructure and/or the horizontal surface.

9. The vehicle of claim 8, wherein the at least one processor is further configured to compare the features of the infrastructure and/or horizontal surface to features of the modeled infrastructure type to determine if the features of the infrastructure and/or horizontal surface indicate that the infrastructure at the location matches the modeled infrastructure type and if so the infrastructure is localized.

10. The vehicle of claim 9 wherein the features of the modeled infrastructure type include dimensions of one or more edges of a modeled horizontal surface.

11. The vehicle of claim 10, wherein the features of the modeled infrastructure type include dimensions of a plurality of edges of the modeled horizontal surface.

12. The vehicle of claim 10, wherein the modeled horizontal surface is a drop surface configured to support the payload.

13. The vehicle of claim 12, wherein the features of the modeled infrastructure type include a height of the drop surface.

14. The vehicle of claim 12, wherein the features of the modeled infrastructure type include an orientation of the drop surface.

15. The vehicle of claim 12, wherein the features of the modeled infrastructure type include a surface density of the drop surface.

16. The vehicle of claim 10, wherein the modeled horizontal surface is predefined as a number of points or a point density, wherein the point density is a number of points per square meter of surface.

17. The vehicle of claim 11, wherein the at least one processor is further configured to localize the infrastructure based on one or more of the edges of the infrastructure matching one or more edges of the modeled infrastructure type.

18. The vehicle of claim 11, wherein the at least one processor is further configured to localize the infrastructure based on one or more of the edges of the horizontal surface matching one or more edges of the modeled horizontal surface.

19. The vehicle of claim 12, wherein the at least one processor is further configured to localize the infrastructure based on the height and orientation of the drop surface matching the modeled infrastructure type.

20. The vehicle of claim 1, wherein the at least one processor is further configured to generate a volume of interest (VOI) that has the same or greater dimensions than the payload and to use the VOI to determine if the horizontal surface is obstruction free.

21. The vehicle of claim 20, wherein the dimensions of the VOI are substantially the same as the dimensions of the payload.

22. The vehicle of claim 20, wherein if the infrastructure is localized, the processor is further configured to associate the VOI with the horizontal surface and process the sensor data to determine if an obstruction is indicated within the VOI.

23. The vehicle of claim 22, wherein if an obstruction is not indicated within the VOI, the processor is further configured to generate a signal indicating that the horizontal infrastructure is obstruction free.

24. The vehicle of claim 23, wherein if the horizontal infrastructure is obstruction free, the payload engagement apparatus is configured to process the signal to deliver the payload to the horizontal surface.

25. The vehicle of claim 22, wherein if an obstruction is indicated within the VOI, the processor is further configured to generate a signal indicating that the horizontal infrastructure is not obstruction free.

26. The vehicle of claim 25, wherein if the horizontal infrastructure is not obstruction free, the payload engagement apparatus is configured to process the signal to abort delivery of the payload to the horizontal surface.

27. A method of horizontal infrastructure assessment, comprising:
providing a robotic vehicle comprising a navigation system configured to autonomously navigate the vehicle to a location, a payload engagement apparatus configured to pick and/or drop a payload at the location, one or more sensors, and at least one processor in communication with at least one storage device;
the one or more sensors collecting three-dimensional (3D) sensor data of an infrastructure at the location; and
the at least one processor processing the collected sensor data to perform an infrastructure localization analysis to determine if the infrastructure is a modeled infrastructure type and if so to determine if a horizontal surface of the infrastructure is obstruction free.

28.-52. (canceled)
